(19) United States
(12) Patent Application Publication
(10) Pub. No.: US 2014/0136561 A1
(43) Pub. Date: May 15, 2014

(54) Recipe Webpage Ingredients Identification

(71) Applicants: Kevin J. Fahey, Glencoe, IL (US); Niraj Swami, Streamwood, IL (US)

(72) Inventors: Kevin J. Fahey, Glencoe, IL (US); Niraj Swami, Streamwood, IL (US)

(21) Appl. No.: 13/802,795

(22) Filed: Mar. 14, 2013

Related U.S. Application Data
(60) Provisional application No. 61/726,658, filed on Nov. 15, 2012.

(51) Int. Cl. G06F 17/22; G06F 17/30

(52) U.S. Cl. CPC G06F 17/2247; G06F 17/30386
USPC 707/758; 715/235

(57) ABSTRACT

A parser unit of an apparatus in an example identifies individual ingredients on a recipe webpage. The parser unit in an example accesses source contents of the recipe webpage to identify any ingredients that are listed on the recipe webpage through employment of style sheet detection.

### DESCRIPTION OF THE DRAWINGS

Features of exemplary implementations of the invention will become apparent from the description, the claims, and the accompanying drawings in which:

FIG. 1 is a representation of an implementation of an apparatus that comprises a page source, a Cascading Style Sheet (CSS) Class Parser, a CSS Class database (DB), a CSS Class interpreter, a detail displayer, and a phrase detail database.

FIG. 2 is a representation of an exemplary logic flow for parsing of a webpage's source in an implementation of the apparatus of FIG. 1.

FIG. 3 is a representation of an implementation of a Cascading Style Sheet Parsing Algorithm in an implementation of the apparatus of FIG. 1.

FIG. 3 is a representation of an exemplary process flow with the CSS Class Parser and the CSS Class interpreter referencing ingredient phrases that deliver coupon details from the phrase detail database in an implementation of the apparatus of FIG. 1.

FIG. 4 is a representation of an implementation of an online recipe page of an implementation of the apparatus of FIG. 1.

FIG. 5 is a representation of an implementation of matching deals of an implementation of the apparatus of FIG. 4 and illustrates a pop-up.

FIG. 6 is similar to FIG. 5 and illustrates a custom printable page.

FIG. 7 is a representation of an implementation of a mobile application of an implementation of the apparatus of FIG. 1.

FIG. 8 is a representation of an implementation of matching deals of an implementation of the apparatus of FIG. 7.

FIG. 9 is a representation of the CSS Class Parser and the CSS Class interpreter of an implementation of the apparatus of FIG. 1.

FIG. 10 is a representation of a sync action in an implementation of the apparatus of FIG. 1 and illustrates a client verifying and receiving sync updates with respect to the parser data.

FIG. 11 is a representation of an implementation of the apparatus of FIG. 1 and illustrates a user may interact with a user interface on a client device 902 that may communicate with a server on a computer system.

### DETAILED DESCRIPTION

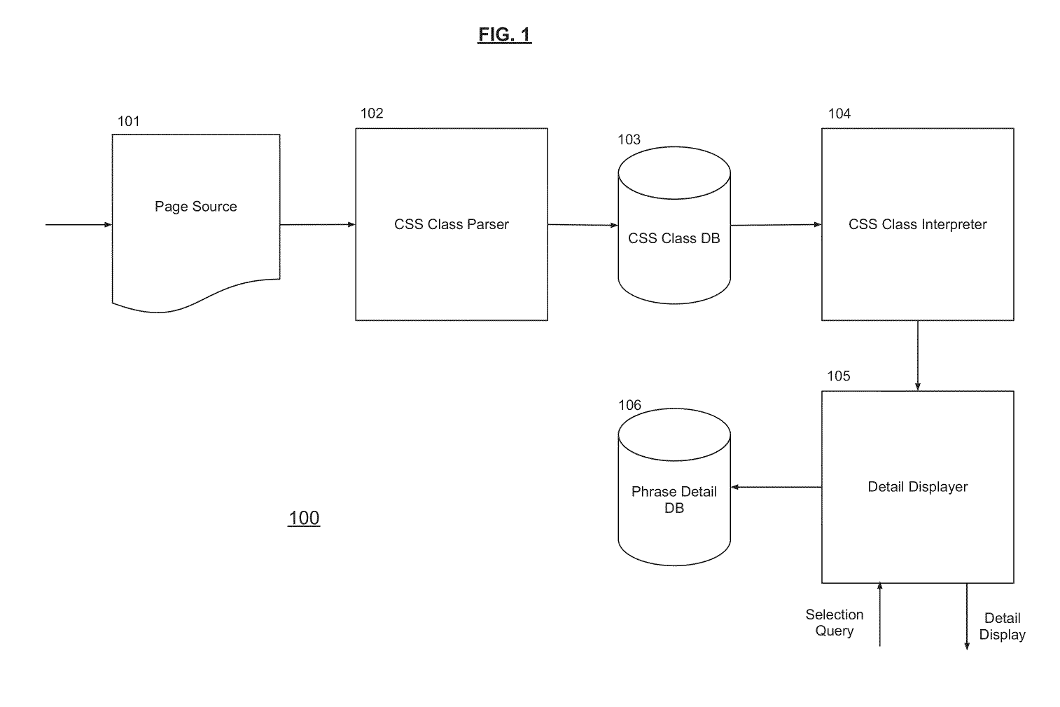

Turning to FIG. 1, an implementation of an apparatus 100 comprises one or more of a page source 101, a Cascading Style Sheet (CSS) Class Parser 102, a CSS Class database (DB) 103, a CSS Class interpreter 104, a detail displayer 105, and a phrase detail database 106. The page source 101 in an example comprises a recipe webpage's source, represented in a combination of HTML, Script and CSS (Cascading Style Sheet) files. The CSS Class database (DB) 103 in an example comprises an accompanying database for the CSS Class parser 102. This basic structure relies on parsing the page source 101 of a page requested by a user from a browser using a set of rules that identify patterns to provide details via the detail displayer 105.

According to FIG. 1, once the HTML page's source is loaded (101), the CSS Class Parser module (102) parses the markup into an array using delimiters loaded from the CSS Class DB (103). The results are held in memory in form of a CSS Interpreter (104), which is a module that iterates against the Details Displayer module (105). The Details Displayer module performs a look up on the Phrase Detail DB (106) and based on selection queries performed by the user, it displays a list of details.

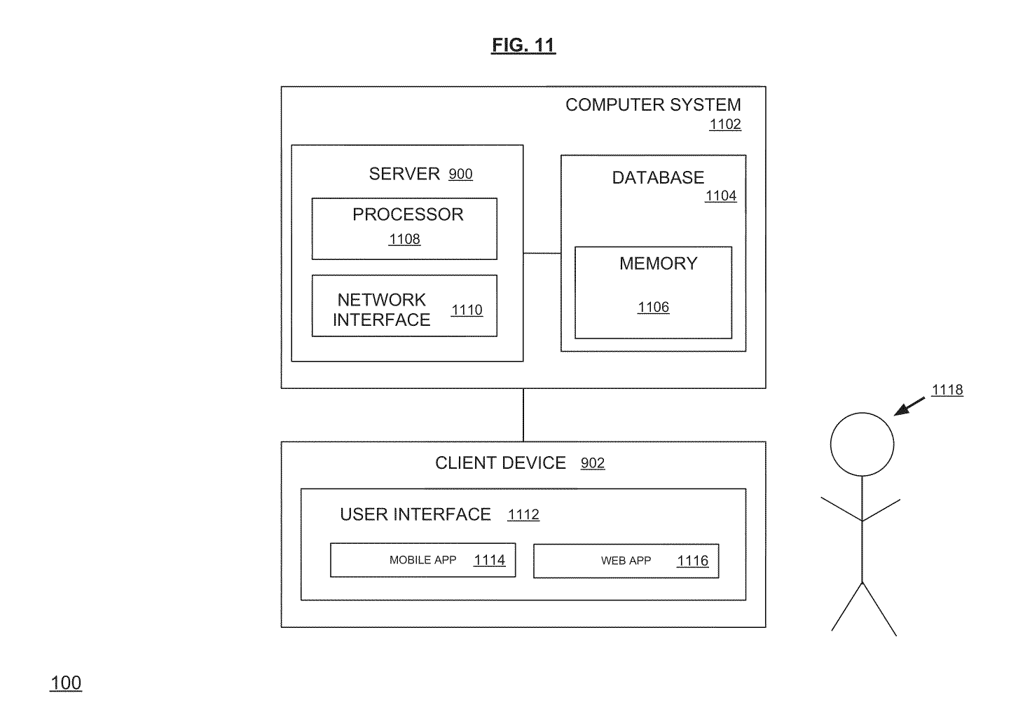

Before we elaborate the flow of an implementation of the apparatus 100, please refer to FIG. 11 to see a high-level architecture of how a user (1118) may interact with a user interface (1112), represented in form of a mobile app (1114) or a web app (1116) on the client device 902, which would then communicate with the server (900) on a remote computer system (1102).

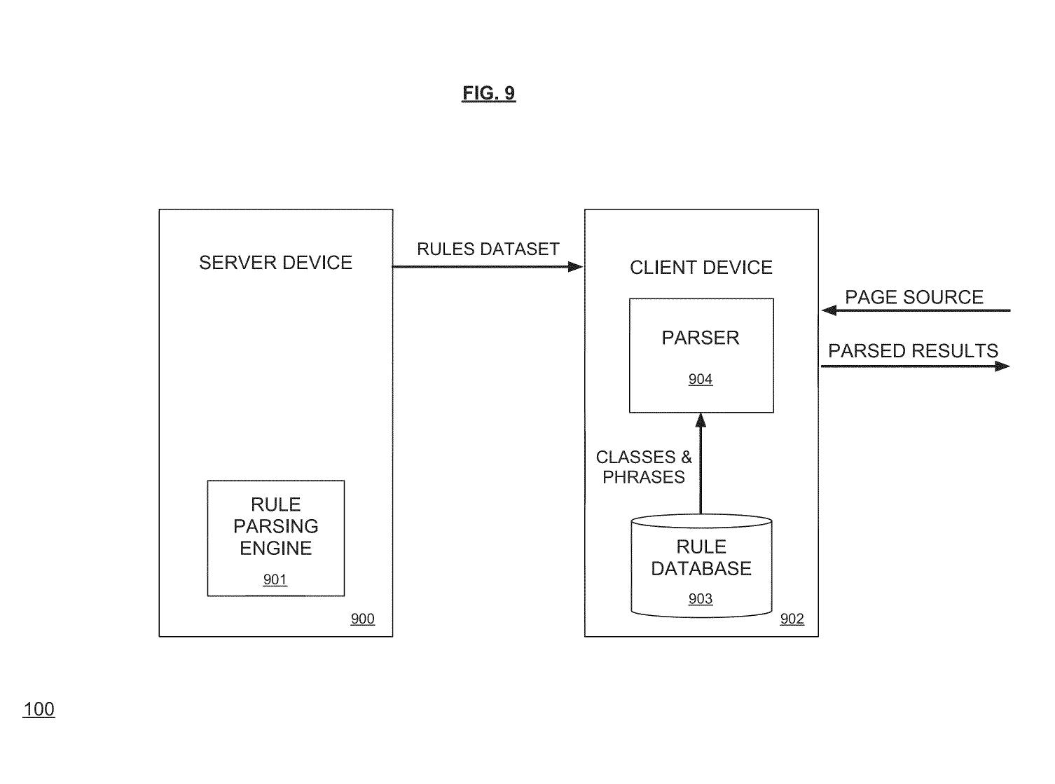

Please refer to FIG. 9 for a detailed description of how the CSS Class Parser 102 may be architected in a server-client design. FIG. 9 depicts a server device 900, which acts as a central repository for the CSS rules, represented in the Rule Parsing Engine (901). A client device 902 receives a rules dataset that it utilizes to create the localized version of the rule database (903), which communicates CSS Classes and Phrases as requested by the Parser (904; also identified in FIG. 1 as the CSS Class Parser 102).

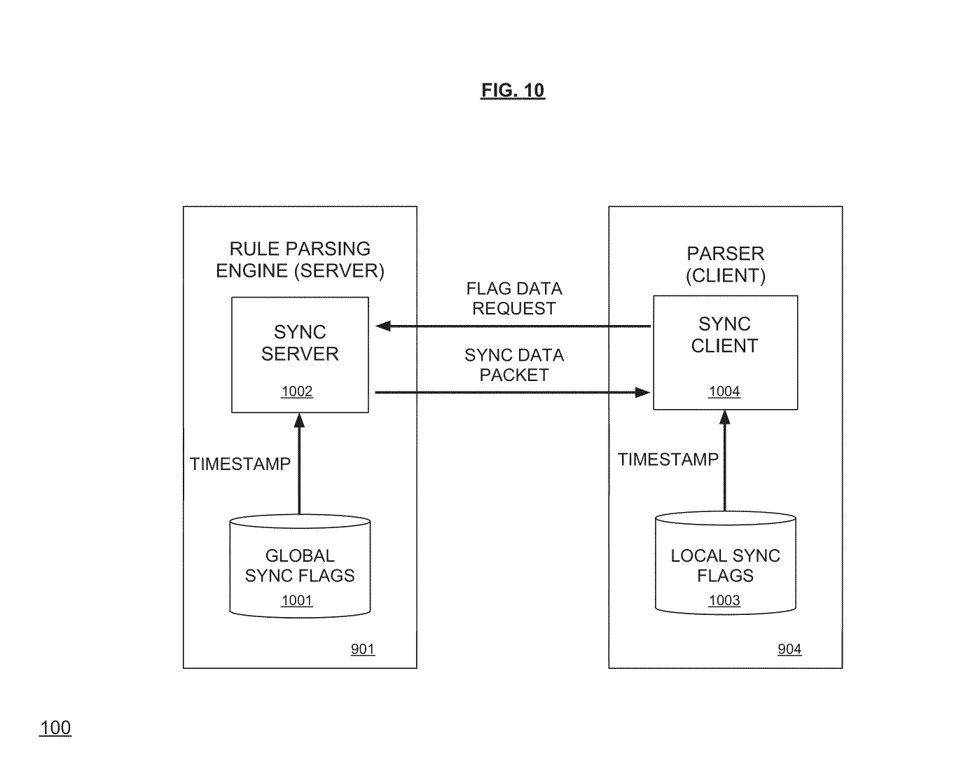

To further detail the architecture underlying an implementation of the CSS Class Parser on the client side (904 from FIG. 9) and the server-side Rule Parsing Engine (901 from FIG. 9), please refer to FIG. 10. The client side Parser (904 in FIGS. 9 & 10) comprises of a sync client (1004) that uses timestamps to keep a localized database of “sync-flags” (1003) that identify the rule states on the client-side device/application in an implementation of the apparatus 100. The sync client (1004) exchanges flag requests with the sync server module (1002) of the Rule Parsing Engine (901 from FIG. 9) by calculating and comparing timestamp-based globalized sync flags (1001).

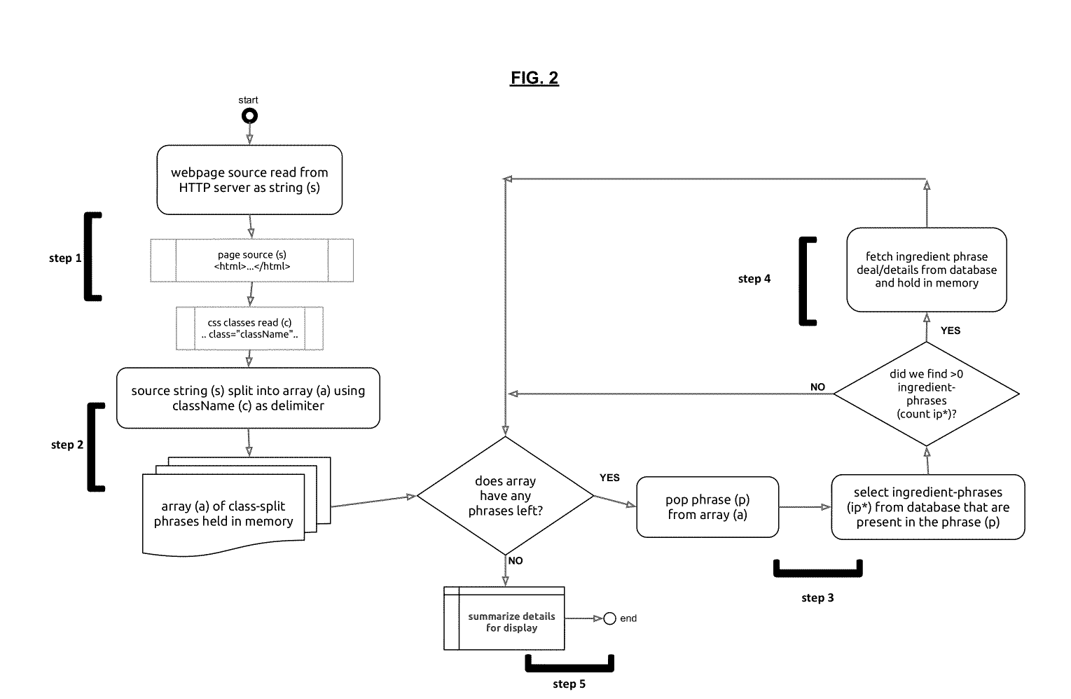

Please refer to FIG. 2 for a description of how the parsing of a recipe webpage's source works in the demonstrated application, CouponMyRecipe, with an implementation of an apparatus 100. The algorithm, referred to as CSSPA (Cascading Style Sheet Parsing Algorithm), is a source-analyzing routine that parses out a database of “phrases” from a web-page's source content using cascading style sheet based search, which relies on the specific class attributes of the HTML nodes. As per FIG. 2, when a web page is read from an HTTP server (either in a web-browser, or any HTTP serving utility on the client side), the page source is resourced into the algorithm as an input (see step 1). Next, the algorithm creates a catalogued array of cascading style sheet classes. Based on an iterator that steps through this catalogued array, each phrase (defined as a step in this array) is compared against a database of ingredient-entries (see step 2 followed by step 3). If a match is found, then a tally is recorded in another array (see step 4). This is iterated as long as there are “phrases” in the catalog. Once all phrases from the catalog have been compared and parsed, the output of each phrase's tally is presented to the user as a list of ingredient specific details (deals, value, location, etc. open to implementor's interpretation), as in step 5.

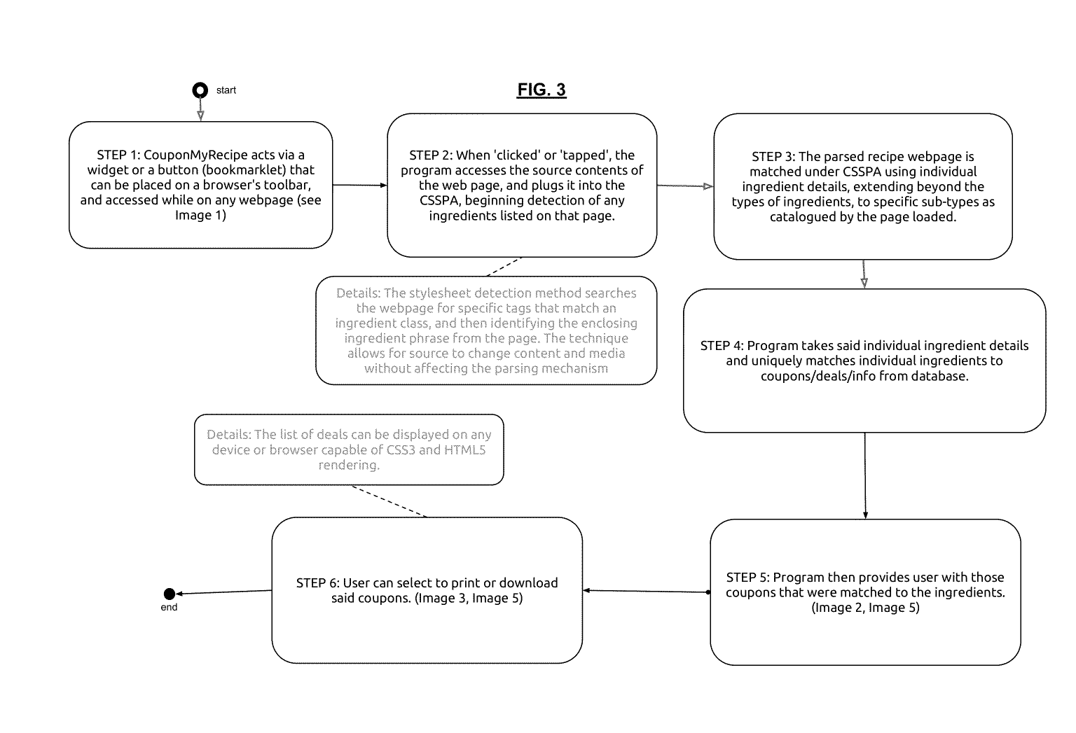

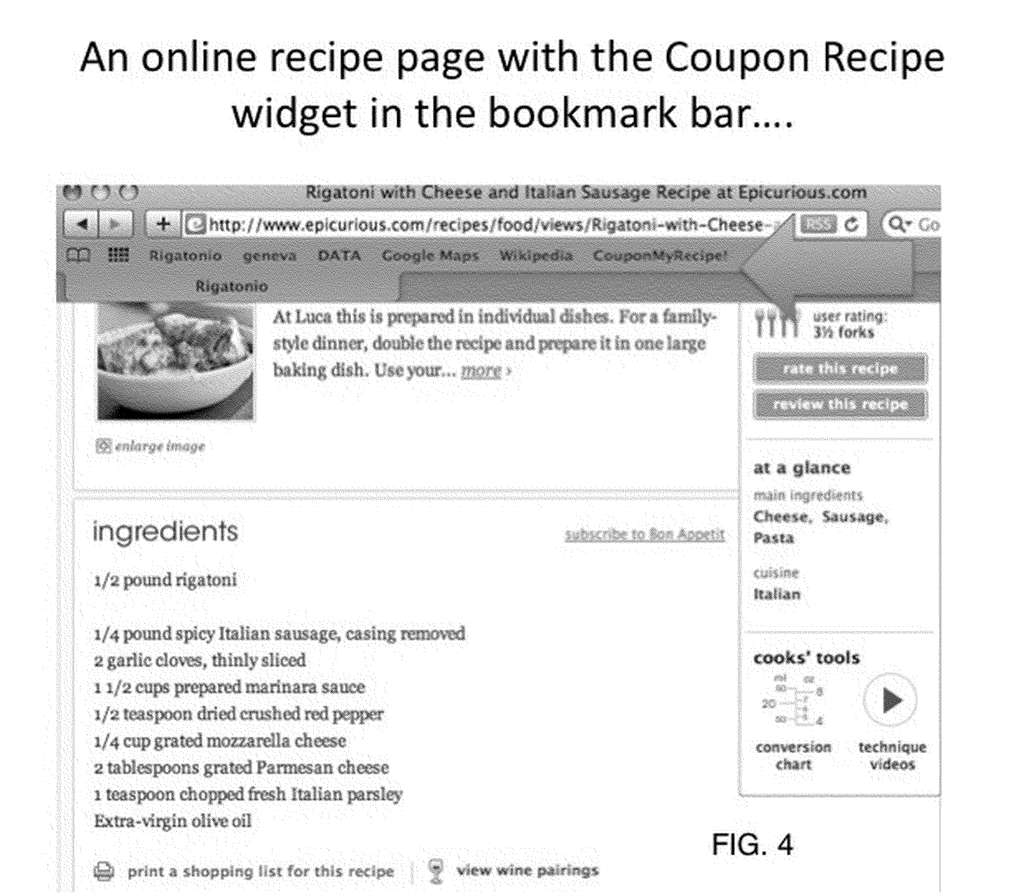

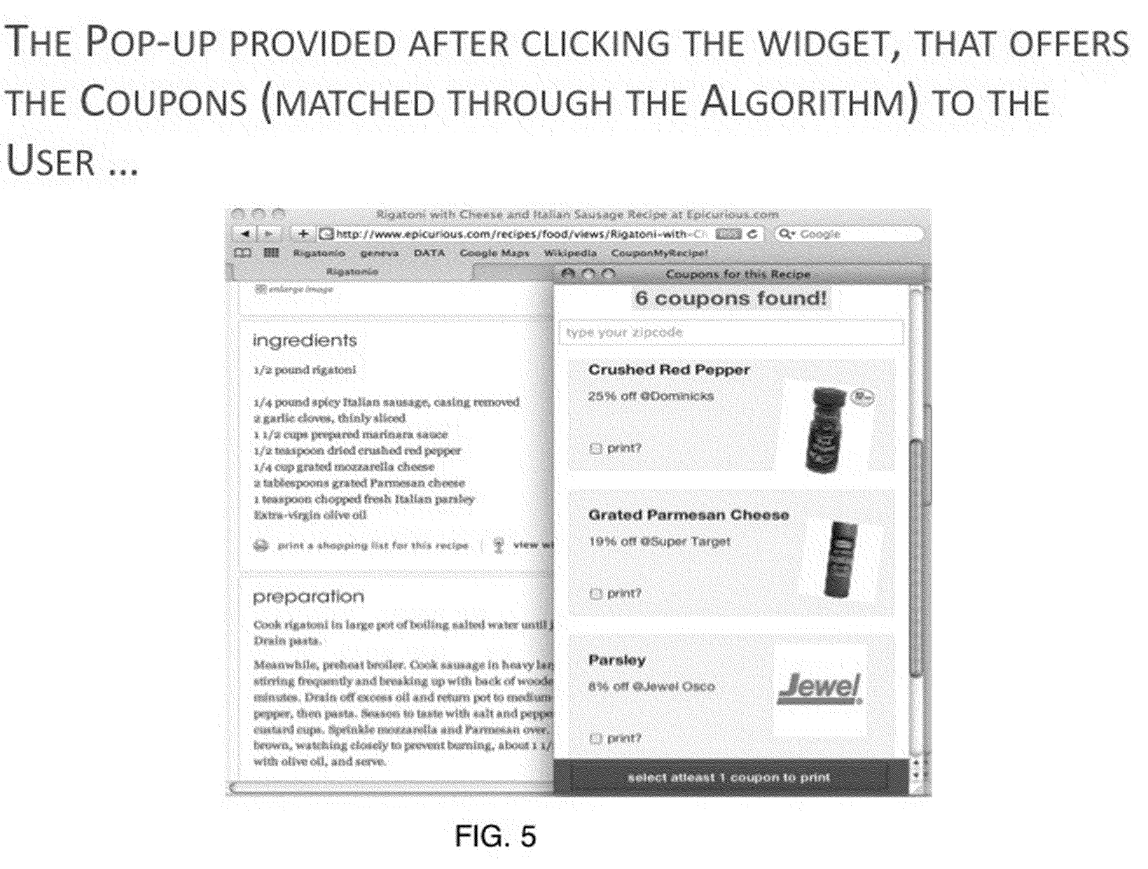

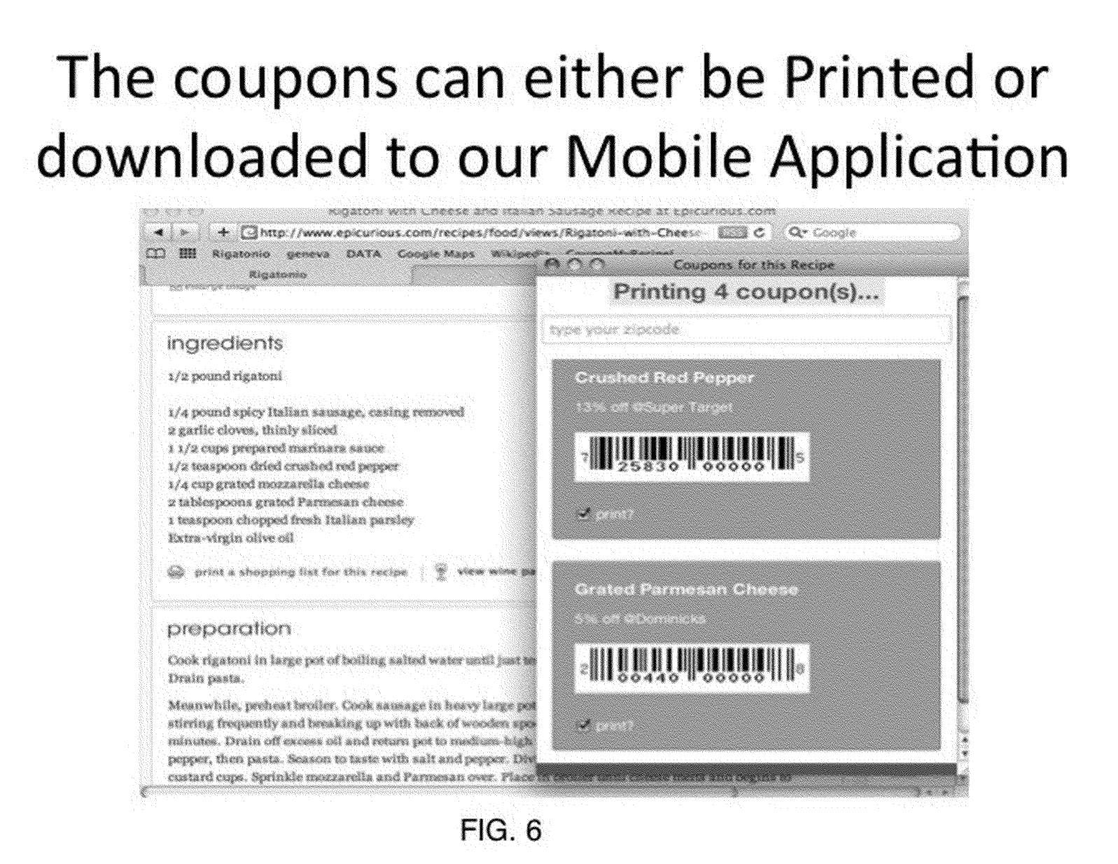

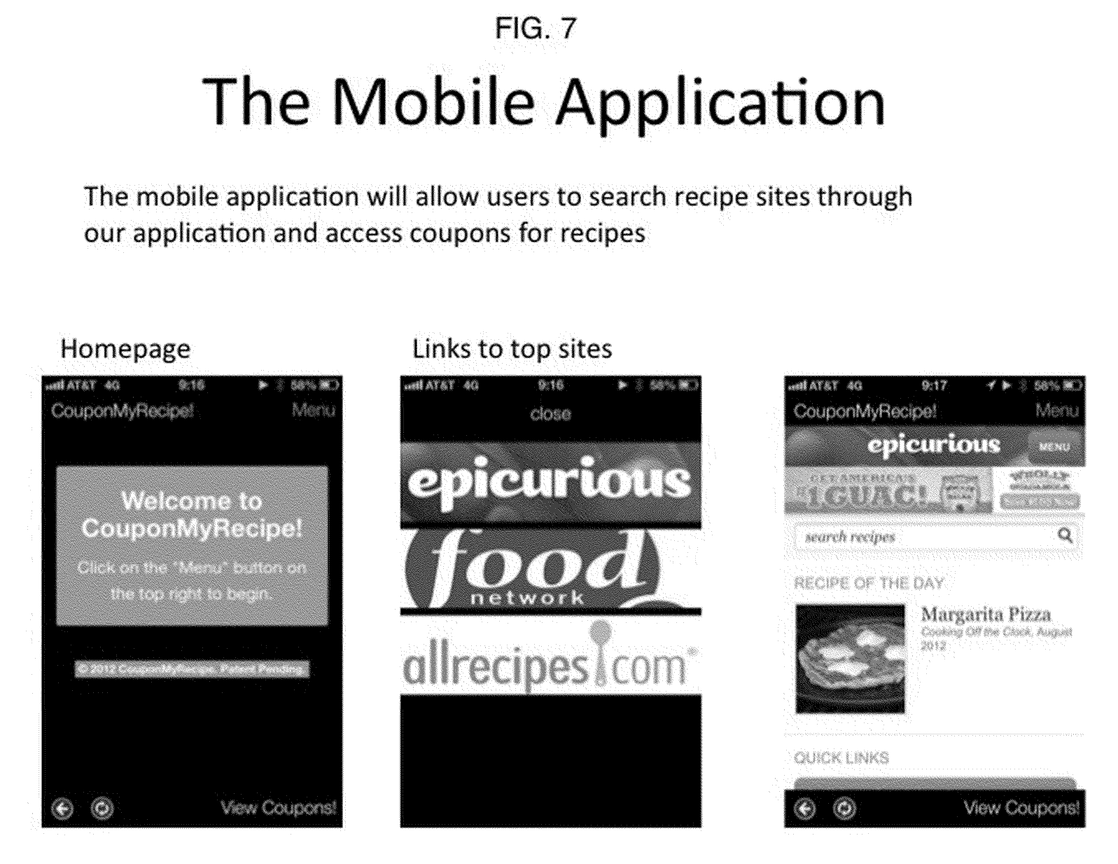

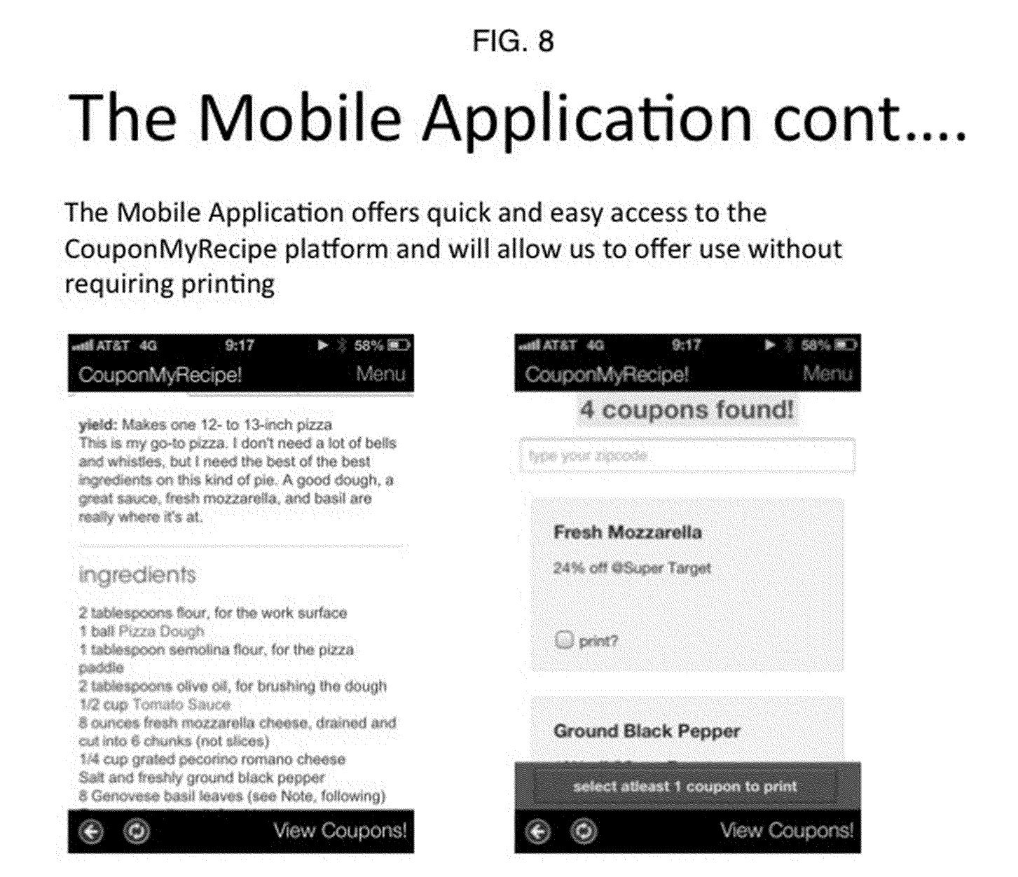

The implementation of CSSPA in the context of CouponMyRecipe is described in FIG. 3. The service resides in form of a bookmarklet or a custom application that allows browser source access via JavaScript (STEP 1, also demonstrated as an implementation in FIG. 4). Once a recipe webpage is visited, the user may click on the CouponMyRecipe button/bookmarklet to trigger the CS SPA routine on that particular webpage's source (STEP 2). Based on ingredient tags that CSSPA has been configured to detect in CSS classes, the sub-types and extended details from the recipe webpage around ingredients are captured and catalogued (STEP 3) for further matching with the deal database (STEP 4). The matching deals are then listed in order and presented to the end user (STEP 5), either in the form of a pop-up, or a custom printable page that can be accessed on the device the user is browsing on (STEP 6, as demonstrated in FIG. 5, FIG. 6, FIG. 7, and FIG. 8).

Program identifies individual ingredients on a recipe webpage. The program comprises of a software module that can access the source contents of a web page to identify any ingredients that are listed on the page by using a style sheet detection method. The style sheet detection method searches the webpage for specific tags that match an ingredient class, and then identifying the enclosing ingredient phrase from the page. The technique allows for source to change content and media without affecting the parsing mechanism.

Program parses recipe webpage into individual ingredient details, extending beyond types of ingredients, to specific sub-types. The program using a string-length algorithm that relies on page source style sheets to identify individual ingredient details pertaining to the type and the sub-type. For instance, the algorithm splits each ingredient phrase (as identified in claim 1) using decreasing order of the length of each string, and tallies the results up for each type and sub-type of ingredient. For instant, a sample phrase of “3 ounces of brown sugar” parses in “brown sugar” and “sugar” as the ingredient strings - matched from the source style sheets as specified by the recipe-page author. For efficiency reasons, the algorithm parses in a decreasing order of string length that best matches a database entry for the ingredients only.

Program uniquely matches individual ingredients to coupons/deals/info from database. The program utilizes a reverse matching algorithm to find the best-fit match to an ingredient phrase from a list of tags provided by a database. The match reveals information pertinent to the row in the database with the appropriate tag. Furthermore, the tags can also incorporate location; personal preferences and product information to further tailor the matched result to the queried ingredient phrase.

Program provides users with said matching details, such as coupons and deals. The program relies on responsive web page to create a uniform experience across any modern browser and client device using a single code base.

Program can incorporate integration with loyalty/reward systems. Program allows integration with reward/loyalty systems so that ingredient details and loyalty purchases can be further tied in for customized deals.

An implementation of the apparatus 100 comprises an algorithm, procedure, program, process, mechanism, engine, model, coordinator, module, unit, application, software, code, and/or logic. An implementation of the apparatus 100 comprises one or more user-level programs, for example, user interface logic residing in one or more user-level program files.

An implementation of the apparatus 100 comprises a plurality of components such as one or more of electronic components, chemical components, organic components, mechanical components, hardware components, optical components, and/or computer software components. A number of such components may be combined or divided in an implementation of the apparatus 100. One or more components of an implementation of the apparatus 100 and/or one or more parts thereof may comprise one or more of a computing, communication, interactive, and/or imaging device, interface, computer, and/or machine. One or more components of an implementation of the apparatus 100 and/or one or more parts thereof may serve to allow selection, employment, channeling, processing, analysis, communication, and/or transformation of electrical signals and/or between and/or among physical, logical, transitional, transitory, persistent, and/or electrical signals, inputs, outputs, measurements, and/or representations.

A plurality of instances of a particular component may be present in an implementation of the apparatus 100. One or more features described herein in connection with one or more components and/or one or more parts thereof may be applicable and/or extendible analogously to one or more other instances of the particular component and/or other components in an implementation of the apparatus 100. One or more features described herein in connection with one or more components and/or one or more parts thereof may be omitted from or modified in one or more other instances of the particular component and/or other components in an implementation of the apparatus 100. An exemplary technical effect is one or more exemplary and/or desirable functions, approaches, and/or procedures. An exemplary component of an implementation of the apparatus 100 may employ and/or comprise a set and/or series of computer instructions written in or implemented with any of a number of programming languages, as will be appreciated by those skilled in the art.

An implementation of the apparatus 100 may comprise any (e.g., horizontal, oblique, angled, or vertical) orientation, with the description and figures herein illustrating an exemplary orientation of an exemplary implementation of the apparatus 100, for explanatory purposes. One or more components of an implementation of the apparatus 100 and/or one or more parts thereof may occupy a number of locations of the apparatus 100.

An implementation of the apparatus 100 may encompass an article and/or an article of manufacture. The article may comprise one or more computer-readable signal-bearing media. The article may comprise means and/or instructions in the one or more media for one or more exemplary and/or desirable functions, approaches, and/or procedures.

An implementation of the apparatus 100 may employ one or more computer-readable signal-bearing media. A computer-readable signal-bearing medium may store software, firmware and/or assembly language for performing one or more portions of an implementation of the apparatus 100. An example of a computer-readable signal bearing medium for an implementation of the apparatus 100 may comprise a memory and/or recordable data storage medium of one or more of the computer system 1102, the memory 1106, the client device 902, the server 900, and/or the database 1104. A computer-readable signal-bearing medium for an implementation of the apparatus 100 in an example may comprise one or more of a magnetic, electrical, optical, biological, chemical, and/or atomic data storage medium. For example, an implementation of the computer-readable signal-bearing medium may comprise one or more flash drives, optical discs, memory cards, computer networks, CDs (compact discs), DVDs (digital video discs), hard drives, portable drives, and/or electronic memory. A computer-readable signal-bearing medium in an example may comprise a physical computer medium and/or computer-readable signal-bearing tangible medium.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a parser unit that identifies individual ingredients on a recipe webpage;
wherein the parser unit accesses source contents of the recipe webpage to identify any ingredients that are listed on the recipe webpage through employment of style sheet detection.

2. The apparatus of claim 1, wherein the parser unit employs the style sheet detection to search the recipe webpage for specific tags that match an ingredient class and subsequently identify an enclosing ingredient phrase from the recipe webpage.

3. The apparatus of claim 1, wherein the parser unit accesses the source contents of the recipe webpage to identify the any ingredients that are listed on the recipe webpage through employment of style sheet detection regardless of change in the source contents.

4. The apparatus of claim 1, wherein the parser unit accesses the source contents of the recipe webpage to identify the any ingredients that are listed on the recipe webpage through employment of style sheet detection regardless of change in media of the source contents.

5. An apparatus, comprising:
a parser unit that parses a recipe webpage into individual ingredient details to types of ingredients and specific sub-types of ingredients;
wherein the parser unit employs page source style sheets to identify individual ingredient details connected with the types of ingredients and the specific sub-types of ingredients.

6. A method, comprising the steps of:
accessing a list of tags of a database; and
employing the list of tags to match individual ingredients specifically to ingredient-specific details from a database.
